(19) United States
(12) Patent Application Publication
(10) Pub. No.: US 2011/0281483 A1
(43) Pub. Date: Nov. 17, 2011

(54) Waterproofing Compound and Waterproofing-Processing Method for Waterproofing a Wide Variety of Natual and Synthetic Fabrics and Materials

(76) Inventors: Franz von Hirschmann, Puyallup, WA (US); Richard Edwards, Federal Way, WA (US)

(21) Appl. No.: 13/006,228

(22) Filed: Jan. 13, 2011

Related U.S. Application Data
(60) Provisional application No. 61/294,776, filed on Jan. 13, 2010.

(51) Int. Cl. B32B 27/04; B05D 5/00; B05D 3/02; D06M 15/277

(52) U.S. Cl. 442/79; 252/8.62; 427/372.2

(57) ABSTRACT

Embodiments of the present invention employ the perfluoroalkyl acrylic copolymerisate PD-1, produced by the Clariant Corporation, and certain other similar perfluoroalkyl acrylic copolymerisates, for waterproofing a wide variety of natural and synthetic fabrics and materials. In one embodiment of the present invention, fabrics and materials are passed through a bath of PD-1, or certain other perfluoroalkyl acrylic copolymerisates, and the material or fabric is then cured for a period of time within a range of periods of time specific to the type of material or fabric at a temperature within a range of temperatures specific to the type of material or fabric in order to create a remarkably waterproof, but breathable material or fabric with characteristics and properties identical or similar to those of the untreated fabric. Thus, embodiments of the present invention provide for remarkable degrees of waterproofing of natural and synthetic fabrics, while retaining the breathability characteristics of the natural and synthetic fabrics and materials as well as many other characteristics and properties, including texture, thickness, weight, and other characteristics and properties desirable to users of the materials and fabrics as well as products constructed from the materials and fabrics.

### CROSS-REFERENCE TO RELATED APPLICATION

This application claims the benefit of Provisional Application No. 61/294,776, filed Jan. 13, 2010.

### TECHNICAL FIELD

The present invention is related to waterproofing compounds and methods for applying the compounds to various types of natural and synthetic fabrics and materials.

### BACKGROUND OF THE INVENTION

Waterproofing of fabrics and materials has been used for many hundreds of years to produce weather-resistant and weatherproof materials for clothing, tents, canopies, and many other applications. Commonly used waterproofing methods involve impregnating fabrics and materials with waxes and/or oils, coating fabrics and materials with various polymeric waterproof coatings, and using a newer class of layers and coatings, many of which are based on fluorinated polymers, including Teflon, which provide waterproofing but which contain micropores that allow water vapor to pass through the fabrics and materials. These breathable membranes and layers are particularly useful for clothing, allowing those wearing clothing made with the breathable layers and coatings to obtain protection from rain and other environmental moisture while remaining relatively dry despite exercise and activity, because the breathable layers and coatings allow perspiration and moisture to pass through the breathable layers and coatings as water vapor. The older waterproofing techniques, including oil and/or wax impregnation and fully waterproof coatings generally fail in conditions under which water vapor is internally generated, since the water vapor is trapped, and quickly condenses to form liquid water that cannot pass through the coating.

Unfortunately, the breathable layers and coatings based on Teflon-like materials and other microporous materials that can pass water vapor suffer from a number of disadvantages. First, the materials are relatively expensive, and represent an additional expense over the structural materials and fabrics used for waterproof clothing, tents, and other applications. In certain uses, where the breathable fabrics and materials are exposed to environmental dirt and other contamination, the micropores of the breathable layers may become clogged, over time, with dirt and grime, and thus fail to pass water vapor. Additionally, adding layers and coatings to fabrics significantly changes the weight, feel, and other characteristics of the fabrics and materials. Often these effects are undesirable, and lead to thick, heavy, difficult-to-tailor fabrics and materials less attractive than familiar, non-waterproof materials, including denim, rayon, and other natural and synthetic fabrics and materials. Purchasers, users, manufacturers, and designers of a variety of different types of products fashioned from fabrics and materials, including clothing, tents, canopies, awnings, shoes, gloves, and other such products continue to seek improved waterproof, but breathable fabrics and materials that provide lighter, thinner, cheaper, and more pleasing and useful materials for clothing and other applications.

### SUMMARY OF THE INVENTION

Embodiments of the present invention employ the perfluoroalkyl acrylic copolymerisate PD-1, produced by the Clariant Corporation, and certain other similar perfluoroalkyl acrylic copolymerisates, for waterproofing a wide variety of natural and synthetic fabrics and materials. In one embodiment of the present invention, fabrics and materials are passed through a bath of PD-1, or certain other perfluoroalkyl acrylic copolymerisates, and the material or fabric is then cured for a period of time within a range of periods of time specific to the type of material or fabric at a temperature within a range of temperatures specific to the type of material or fabric in order to create a remarkably waterproof, but breathable material or fabric with characteristics and properties identical or similar to those of the untreated fabric. Thus, embodiments of the present invention provide for remarkable degrees of waterproofing of natural and synthetic fabrics, while retaining the breathability characteristics of the natural and synthetic, fabrics and materials as well as many other characteristics and properties, including texture, thickness, weight, and other characteristics and properties desirable to users of the materials and fabrics as well as products constructed from the materials and fabrics.

### BRIEF DESCRIPTION OF THE DRAWINGS

FIG. 1 illustrates various types of polymers.

FIG. 2 shows two closely related, commonly used synthetic-polymer subunits as well as the reaction by which a linear polymer is formed from one of the subunits.

FIG. 3 illustrates a fluoroalkyl side chain and generation of a fluoroalkyl subunit useful for synthetic hydrophobic polymer synthesis.

FIG. 4 illustrates a typical waterproofing process according to various embodiments of the present invention.

FIG. 5 provides representative cure times and temperatures for a variety of different natural and synthetic fabrics according to various embodiments of the present invention.

FIG. 6 illustrates one dramatic example of the hydrophobicity of PD-1-treated materials that represent embodiments of the present invention.

### DETAILED DESCRIPTION OF THE INVENTION

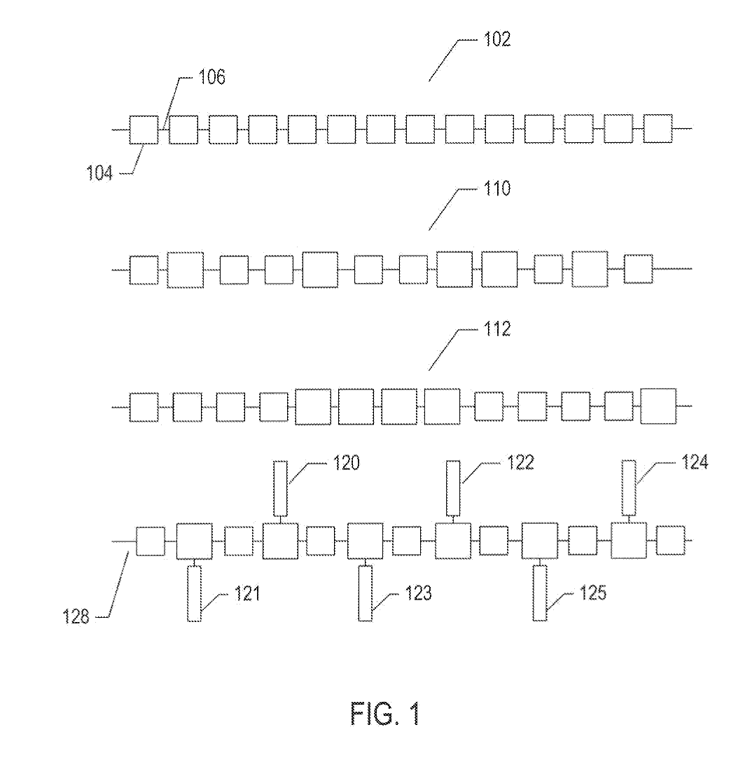

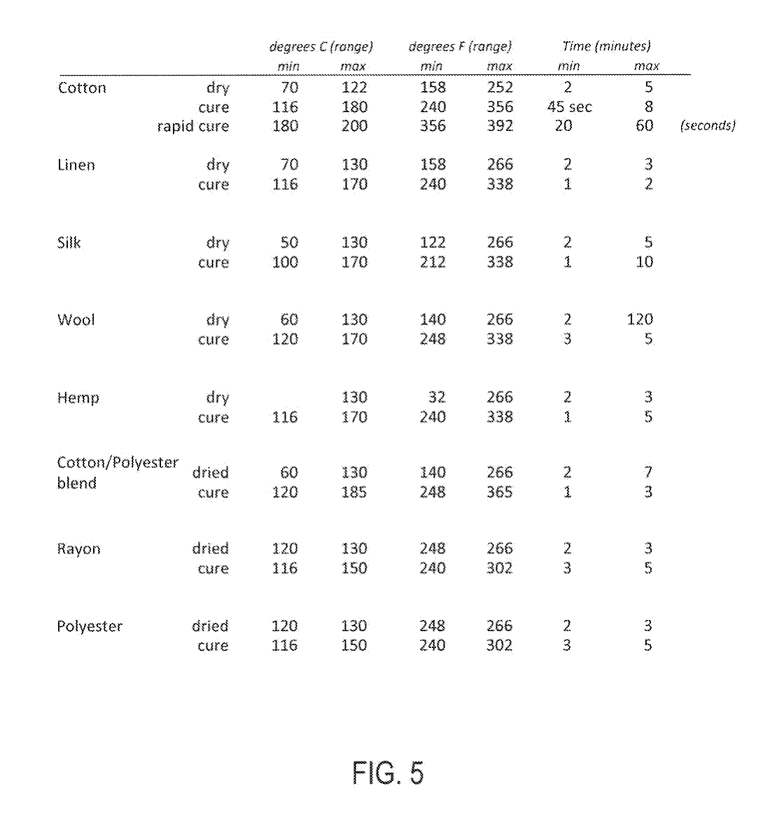

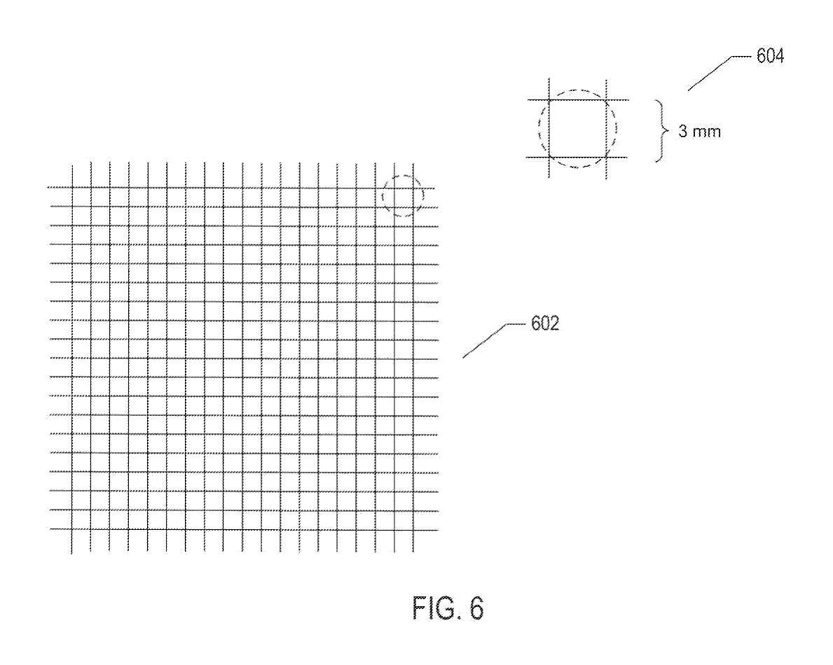

The present invention provides waterproofing compounds and methods for employing the waterproofing compounds to create waterproof fabrics and materials for use in a wide variety of different applications. In the following discussion, the present invention is discussed, in overview, with reference to FIGS. 1-4. Details of various embodiments of the present invention are then discussed with reference to FIGS. 5 and 6. Finally, in an appendix, the Material Safety Data Sheet for the perfluoroalkyl acrylic copolymerisate, PD-1, produced by the Clariant Corporation, is provided.

FIG. 1 illustrates various types of polymers. A polymer is a linear, branching, or network-like macromolecule synthesized from one or a few monomer repeating units. Polymers are widespread in nature and in industry. The structural, catalytic, and information-containing macromolecules of biological organisms are polymers, including proteins, DNA, and RNA. Natural fabrics, including cotton and wool, are biopolymers. Cotton is a polysaccharide and wool is a protein. Most synthetic fabrics and materials are also polymers. In perhaps simplest form, a polymer, schematically represented at the top of FIG. 1 102, is a linear sequence of monomers, including monomer 104, linked together by covalent bonds, including covalent bond 106. Monomers can be any of many different naturally occurring and synthetic organic molecules, and may alternatively be based on silicon and certain other elements. The first representation of a polymer 102 in FIG. 1 is a linear polymer containing a single type of monomer subunit. Other types of polymers include random copolymers 110, in which two or more different types of monomer subunits are randomly ordered in a linear sequence of subunits, and block copolymers 112, in which blocks of two or more different types of monomer subunits alternate along the length of a polymer. Any of these different types of polymers may include side chains, such as side chains 120-125 covalently attached to one type of monomer subunit in an alternating copolymer 128. Polymers may have significantly more complex structures. For example, polysaccharides are synthesized from sugar molecules, each of which may have multiple functional groups from which multiple polymer branches may emanate. This leads to complex, tree-structured, branched polymers and, in certain cases, to two-dimensional network polymers, in which subunits are joined together to form a planar structure, and even three-dimensional structures.

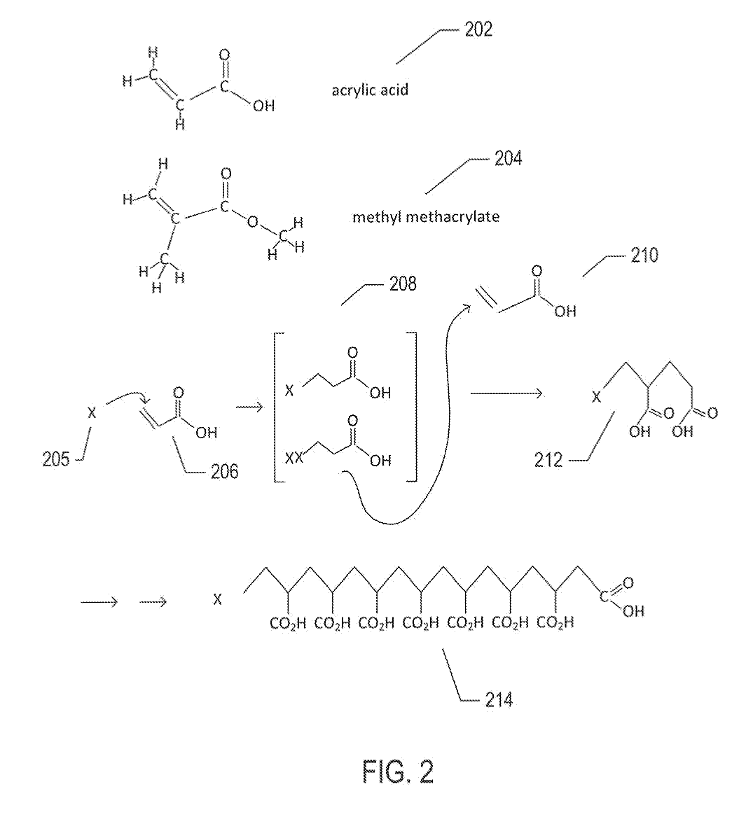

Many types of synthetic organic molecules may be used as the monomer subunits of a synthetic polymer. FIG. 2 shows two closely related, commonly used synthetic-polymer subunits as well as the reaction by which a linear polymer is formed from one of the subunits. The two commonly used subunits include acrylic acid 202 and methyl methacrylate 204. Polymerization of acrylic acid occurs when a radical initiator 204 reacts with a molecule of acrylic acid 206 to produce a polymer-initiating radical 208, two resonance-stabilized forms of which are shown in brackets in FIG. 2, which then reacts with a second molecule of acrylic acid 210 to produce a two-subunit, nascent polymer 212. This nascent polymer is also a radical, and can react by the same mechanism with another molecule of acrylic acid to produce a three-subunit radical. By repeated additions, a long, linear chain of acrylate subunits 214, referred to as polyacrylic acid, is produced. The chain terminates when the radical combines with a hydrogen radical or other chain-terminating chemical entity.

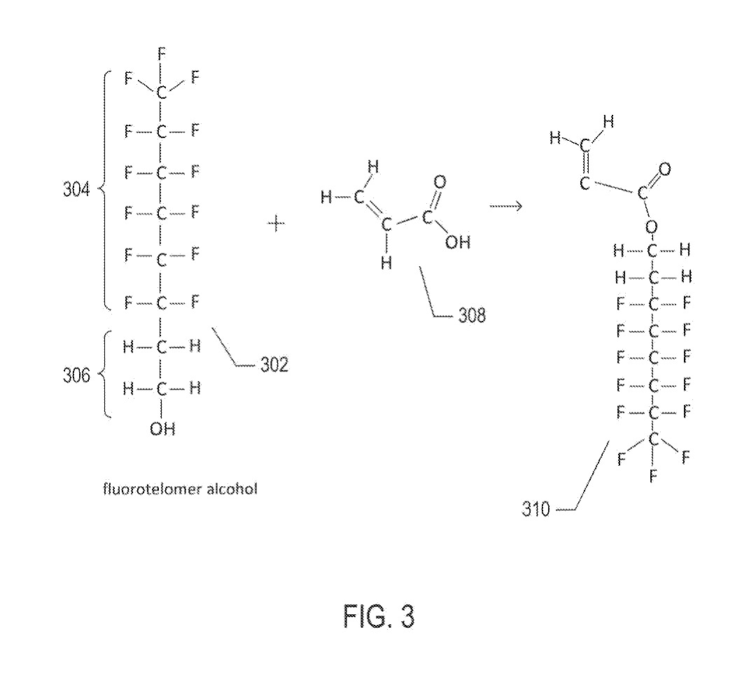

Many different types of hydrophobic polymers, useful for stain repellants, fabric treatments, and other applications employ highly fluorinated polymers and polymer side chains. Fluorinated organic compounds are extremely hydrophobic, significantly more so than saturated hydrocarbons, including linear and branched alkanes. A class of compounds referred to as “fluorotelomer alcohols” are often used as component side chains of hydrophobic synthetic polymers. FIG. 3 illustrates a fluoroalkyl side chain and generation of a fluoroalkyl subunit useful for synthetic hydrophobic polymer synthesis. In FIG. 3, a C-8 fluorotelomer alcohol 302 is shown. These alcohols include a number of perfluoroalkyl carbons 304 covalently attached to an ethanol moiety 306. The fluorotelomer alcohol can be reacted with, for example, acrylic acid 308 to produce a highly fluorinated fluorotelomer-alcohol acrylate ester 310 that can, in turn, be used as the single monomer subunit, or as one of two or more different monomer subunits, for synthesis of various types of highly fluorinated polymers. Alternatively, side chains can be introduced into an already-formed polymer by ester-forming reactions, amide-forming reactions, addition reactions, and other such reactions.

Clariant Corporation has produced a perfluoroalkyl acrylic copolymerisate, essentially a copolymer that includes fluorinated subunits of the class of subunits shown in FIG. 3, that can be dispersed in dipropylene glycol and propanol, oxybis- to create a waterproofing liquid that represents one embodiment of the present invention. The average molecular weight for the perfluoroalkyl acrylic copolymerisate polymer is greater than 25,000 Daltons, and the dispersion includes approximately 30% to 40% of each of the perfluoroalkyl acrylic copolymerisate polymer, dipropylene glycol, and propanol, oxybis-components. Information about the PD-1 perfluoroalkyl acrylic copolymerisate polymeric dispersion that represents one embodiment of the present invention is provided in the Material Safety Data Sheet included in Appendix 1.

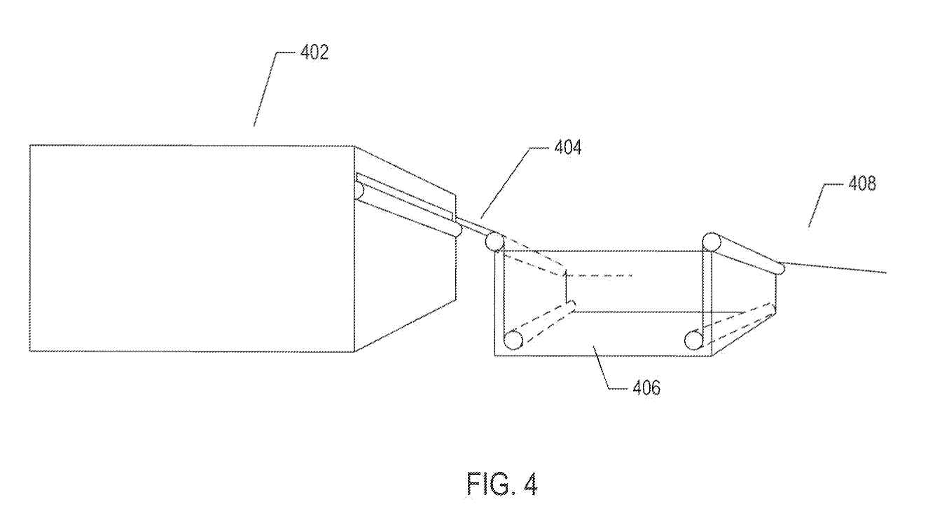

FIG. 4 illustrates a typical waterproofing process according to various embodiments of the present invention. In FIG. 4, a fabric or material-producing machine or system 402 produces a continuous sheet of material or fabric 404 which is then drawn through a tank, or bath, 406 containing the PD-1 waterproofing solution that represents one embodiment of the present invention to produce PD-1-saturated fabric or material 408. The PD-1 saturated fabric or material can then be immediately spooled, or otherwise collected, and cured at a specific temperature for a specific period of time depending on the type of material or fabric being treated. FIG. 5 provides representative cure times and temperatures for a variety of different natural and synthetic fabrics according to various embodiments of the present invention. For example, linen is waterproofed by curing a PD-1-impregnated fabric between 240 degrees F. and 338 degrees F. for between one and two minutes. Following curing, only the PD-1 component of the waterproofing liquid remains within the fabric. The PD-1 waterproofing method can be applied following dying and other chemical treatments of natural and synthetic fabrics without altering the color and other characteristics of the treated fabrics.

The waterproofing methods that represent embodiments of the present invention produce remarkably hydrophobic, waterproof and water-repellant materials and fabrics. Water beads into nearly spherical beads on the surface of the PD-1-treated fabrics and materials and does not penetrate the fabrics and materials after even lengthy periods of time. The PD-1-treated fabrics and materials can be repeatedly washed, ironed, dried, and otherwise processed without degrading the waterproofing provided by method embodiments of the present invention. FIG. 6 illustrates one dramatic example of the hydrophobicity of PD-1-treated materials that represent embodiments of the present invention. As shown in FIG. 6, a very loosely weaved synthetic fabric 602 with pores, or spaces between threads, of up to 3 mm on a side 604, can be fully waterproofed by application of PD-1 according to embodiments of the present invention. Even through the plane of the fabric includes far more empty space than fiber and one can easily see through the fabric, the fabric nonetheless presents a waterproof barrier on which liquid water beads into nearly spherical drops without penetrating the fabric.

Although the present invention has been described in terms of particular embodiments, it is not intended that the invention be limited to these embodiments. Modifications will be apparent to those skilled in the art. For example, any of a wide variety of different natural and synthetic fabrics, materials, cloths, and other such materials can be effectively waterproofed according to method embodiments of the present invention. Although PD-1, produced by the Clariant Corporation, has shown excellent waterproofing characteristics, other perfluoroalkyl acrylic copolymerisates similar to PD-1 can also be employed for waterproofing according to the present invention. There are an astounding number of different applications for waterproofed fabrics and materials that represent embodiments of the present invention. Materials and fabrics waterproofed according to method embodiments of the present invention may be used for clothing, tents, canopies, various types of covers and awnings, for medical applications, including bandages and dressings, for upholstery, carpeting, building materials, and a wide variety of other applications.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A waterproofing liquid for waterproofing fabrics and materials comprising approximately equal portions of:
PD-1;
dipropylene glycol; and
propanol, oxybis-.

2. A method for waterproofing fabrics and materials comprising:
saturating a fabric with a waterproofing liquid containing PD-1; and
curing the saturated fabric for a time within a range of times specific to the type of fabric at a temperature within a range of temperatures specific to the type of fabric.

3. A waterproof fabric or material prepared by the method of claim 2.
